(19) United States
(12) Patent Application Publication
(10) Pub. No.: US 2026/0352568 A1
(43) Pub. Date: Nov. 5, 2026

(54) AI/ML MODEL COMMAND

(71) Applicant: ZTE Corporation, Shenzhen (CN)

(72) Inventors: Xingguang WEI, Shenzhen (CN); Zhaohua LU, Shenzhen (CN); Wenfeng LIU, Shenzhen (CN); Huahua XIAO, Shenzhen (CN); Lun LI, Shenzhen (CN); Yong LI, Shenzhen (CN)

(73) Assignee: ZTE Corporation, Shenzhen, GD (CN)

(21) Appl. No.: 19/728,638

(22) Filed: Jul. 2, 2026

Related U.S. Application Data
(63) Continuation of application No. PCT/CN2024/070913, filed on Jan. 5, 2024.

(51) Int. Cl. H04L 41/16; H04W 24/10

(52) U.S. Cl. CPC H04L 41/16; H04W 24/10

(57) ABSTRACT

A method includes a base station sending to a UE a first command, which first command commands the wireless terminal device to perform at least one of activating one or multiple models, switching to another one or multiple models, updating a configuration or parameter of one or multiple models, receiving one or multiple models transferred from a network, and/or performing performance monitoring of one or multiple models. The wireless terminal device may then receive, in response to receiving the first command, measurement resource transmission from the wireless access network node, and assess performance of the one or multiple models based on the measurement resource transmitted from the wireless access network node.

### CROSS-REFERENCE TO RELATED APPLICATION(S)

This application is a continuation of International Patent Application No. PCT/CN2024/070913, filed Jan. 5, 2024. The contents of International Patent Application No. PCT/CN2024/070913 are herein incorporated by reference in their entirety.

### TECHNICAL FIELD

This disclosure generally relates to handling transmissions in a wireless cellular access network and is specifically directed to mechanisms for providing commands regarding models (e.g., Artificial Intelligence/Machine Learning (AI/ML) models) and/or functionality.

### BACKGROUND

Artificial Intelligence/Machine Learning (AI/ML) is a promising enhancement direction for mobile communication system, e.g., 5G (fifth generation), 5G-A (5G-Advanced) and 6G (sixth generation). With the introduction of AI/ML technology into the mobile communication system, the system operating efficiency is expected to be improved, for example, by reducing the overhead of reference signals via AI/ML inference and prediction.

For a communication system with AI/ML technology, an AI/ML model is adopted, for example, to perform inference. Generally, a model may refer to a functionality, function, functionality module, function module, processing method, information processing method, implementation, feature, feature group, configuration, configuration set, dataset (e.g., for model training), or data-driven algorithms. Generally, these models are performed, calculated, or processed by User Equipment (UE). In various examples, a model may be a data driven algorithm that applies AI/ML techniques to generate a set of outputs based on a set of inputs. Alternatively, a model can be linear or non-linear algorithms or combination of both algorithms. In addition, functionality may refer to a feature enabled by the AI/ML model. Alternatively, functionality may refer to a set of parameters or configurations for one feature. For example, a UE may adopt a convolutional neural network (CNN) model to predict the beams for the communication, and the CNN model is the model and the beam prediction is the functionality. Different models and/or functionalities may be associated with different configurations (e.g., Radio Resource Control (RRC) configuration). Model activation may refer to activating the corresponding configuration for the UE. Similarly, model deactivation, switching, and fallback may refer to deactivating the corresponding configuration, switching the configuration, and falling back to a configuration without the model, respectively.

### SUMMARY

This disclosure generally relates to handling transmissions in a wireless cellular access network and is specifically directed to mechanisms for providing commands regarding models and/or functionality. For example, methods and procedures are disclosed to activate, deactivate, switch, or fallback models together with reference signal triggering and/or assessment report triggering.

When base station indicates to the UE to activate, switch, or update one or multiple models, it is beneficial for the base station to know the performance of the model that is to be activated, switched to, or updated. In this case, measurement resources (e.g., reference signals) can be transmitted to the UE in order to assess the performance of model(s). As such, the base station may better understand how well this model works.

In some exemplary implementations, a method performed by a wireless access network node (WANN) includes sending, to a wireless terminal device (e.g., UE), a first command. Similarly, a method performed by the wireless terminal device includes receiving, from the WANN, the first command. The first command commands the wireless terminal device to perform, and the wireless terminal device may perform, in response to a command in the first command, at least one of the following operations: activating one or multiple models; switching to another one or multiple models; updating a configuration or parameter of one or multiple models; receiving one or multiple models transferred from a network; and/or performing performance monitoring of one or multiple models. The wireless terminal device may then receive, in response to receiving the first command, measurement resource transmission from the wireless access network node, and assess performance of the one or multiple models based on the measurement resource transmitted from the wireless access network node. The method may also include the wireless terminal device generating, in response to receiving the first command or a second command from the WANN, a measurement report based on the measurement resource. The wireless terminal device may then transmit, to the WANN, and the WANN may receive, the measurement report.

In some exemplary implementations, which may be combined with any of the other exemplary implementations disclosed herein, the methods may also include the WANN transmitting, to the wireless terminal device, and the wireless terminal device receiving, the RS as the measurement resource. The method may include the WANN transmitting, to the wireless terminal device, and the wireless terminal device receiving two groups of RS as the measurement resource, including a first RS group and a second RS group, wherein each group of the RS includes one or multiple RS resources. The method may also include the wireless terminal device receiving the one or multiple RS resources in the first RS group and deriving a first set of measurement results, and deriving a second set of measurement results based on the first set of measurement results and the one or multiple models. Alternatively, the method may include the wireless terminal device receiving the one or multiple RS resources in the first RS group, and deriving a second set of measurement results based on the one or multiple RS resources in the first RS group and the one or multiple models. The method may also include the wireless terminal device receiving the one or multiple RS resources in the second RS group and deriving a third set of measurement results based on the one or multiple RS resources in the second RS group. The method may also include the wireless terminal device generating the measurement report based on the second set of measurement results and the third set of measurement results, and the wireless terminal device transmitting, and the WANN receiving the measurement report.

In some exemplary implementations, which may be combined with any of the other exemplary implementations disclosed herein, the methods may include the WANN indicating to the wireless terminal device, and the wireless terminal device receiving an indication of timing information of the two groups of RS, wherein the first RS group and the second RS group are transmitted at different times, wherein the first RS group is transmitted at time T1 and the second group of RS is transmitted at time T2, wherein time T1 is earlier than time T2. The method may also include the WANN indicating, to the wireless terminal device, and the wireless terminal device receiving an indication of the timing information of the two groups of RS, including at least one of the following: a starting time of the first RS group and a starting time of the second RS group; and/or the starting time of the first RS group and a time offset between the first RS group and the second RS group.

In some exemplary implementations, which may be combined with any of the other exemplary implementations disclosed herein, the methods may include the WANN transmitting to the wireless terminal device, and the wireless terminal device receiving the two groups of RS as the measurement resource at a same time. The method may also include the WANN transmitting to the wireless terminal device, and the wireless terminal device receiving the two groups of RS as the measurement resource, wherein the first RS group has a different number of RS resources and/or different number of ports than the second RS group. The method may also include the WANN indicating to the wireless terminal device, and the wireless terminal device receiving an indication of a repetition number of the first RS group and/or the second RS group. In various examples, the RS resources of the first RS group may be the same as the RS resources of the second RS group, or the RS resources of the first RS group may be a subset of the RS resources of the second RS group.

In some exemplary implementations, which may be combined with any of the other exemplary implementations disclosed herein, the methods may include the WANN transmitting to the wireless terminal device, and the wireless terminal device receiving one group of RS as the measurement resource, wherein the group of RS includes one or multiple RS resources. The methods may include the WANN indicating to the wireless terminal device, and the wireless terminal device receiving an indication of timing information of the group of RS, wherein the timing information includes a starting time of the group of RS. The methods may include the wireless terminal device receiving the one or multiple RS resources in the group of RS, deriving a first set of measurement results, and deriving a second set of measurement results based on the first set of measurement results and the one or multiple models. Alternatively, the methods may include the wireless terminal device receiving the one or multiple RS resources in the group of RS, and deriving a second set of measurement results based on the one or multiple RS resources in the group of RS and the one or multiple models. The method may also include the wireless terminal device deriving a third set of measurement results based on the one or multiple RS resources in the second RS group. The methods may also include the wireless terminal device generating the measurement report based on the second set of measurement results and the third set of measurement results, and the wireless terminal device 104 transmitting, and the WANN receiving, the measurement report.

In some exemplary implementations, which may be combined with any of the other exemplary implementations disclosed herein, the methods may include the WANN indicating to the wireless terminal device, and the wireless terminal device receiving an indication of a dataset as the measurement resource. The methods may further include the WANN transmitting to the wireless terminal device, and the wireless terminal device receiving the dataset or a dataset ID, wherein the dataset or a dataset identified by the dataset ID includes a model input dataset and a nominal model output dataset. The methods may include the wireless terminal device using the model input dataset as an input to the one or multiple models to generate an actual model output dataset, and generating the measurement report based on the nominal model output dataset and the actual model output dataset.

In some exemplary implementations, which may be combined with any of the other exemplary implementations disclosed herein, the second set of measurement results or the nominal model output dataset comprises at least one of: channel/signal information; wireless terminal device location information; or beam information. In some implementations, the third set of measurement results or the actual model output dataset have same metrics as the second set of measurement results of the or the nominal model output dataset. The methods may include the wireless terminal device transmitting, and the WANN receiving, the measurement report including the second set of measurement results and the third set of measurement results. The methods may include the wireless terminal device transmitting, and the WANN receiving, the measurement report including a difference or similarity between the second set of measurement results and the third set of measurement results. The methods may include the wireless terminal device transmitting, and the WANN receiving, the measurement report including a difference or similarity between the nominal model output dataset and the actual model output dataset. The methods may include the wireless terminal device transmitting, and the WANN receiving, the measurement report including a prediction accuracy based on the second set of measurement results and the third set of measurement results. The methods may include the wireless terminal device transmitting, and the WANN receiving, the measurement report including a prediction accuracy based on the nominal model output dataset and the actual model output dataset. In certain example, the prediction accuracy includes a number of samples considered as accurate prediction or a percentage of samples of that are considered as accurate prediction. The methods may include the wireless terminal device transmitting, and the WANN receiving, the measurement report including at least one index of a recommended one or more models from the wireless terminal device.

In some exemplary implementations, which may be combined with any of the other exemplary implementations disclosed herein, the methods may include the WANN indicating to the wireless terminal device, and the wireless terminal device receiving an indication of a starting time of the channel or signal carrying the measurement report. This may further include the WANN indicating to the wireless terminal device, and the wireless terminal device receiving an indication of an offset compared to a reference point, wherein the reference point is one of the following: a slot or symbol where the first command is transmitted; a slot or symbol where HARQ-ACK feedback information for the first command is transmitted; or a slot or symbol where the measurement resource finishes transmission.

In some exemplary implementations, which may be combined with any of the other exemplary implementations disclosed herein, the methods may include the wireless terminal device transmitting, and the WANN receiving, the first command via Medium Access Control Control Element (MAC-CE) or Downlink Control Information (DCI) signaling. The methods may include the wireless terminal device including, and the WANN receiving, one or more indexes in the first command, where each index corresponds to a set of RS configurations and measurement report configurations. In certain examples, the RS configurations include configurations for the RS group or RS groups, including a starting time of the RS group or RS groups. In certain examples, the measurement report configurations include configurations of report metrics and a starting time of a channel/signal carrying the measurement report.

In some other implementations, an apparatus for wireless communication such as a network device is disclosed. The network device may include one or more processors and one or more memories, wherein the one or more processors are configured to read computer code from the one or more memories to implement any one of the methods above. The apparatus for wireless communication may be the wireless access network node (e.g., base station) or the wireless terminal device (e.g., UE).

In yet some other implementations, a computer program product is disclosed. The computer program product may include a non-transitory computer-readable medium with computer code stored thereupon, the computer code, when executed by one or more processors, causing the one or more processors to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows a wireless access network with an exemplary uplink, downlink, and control channel configuration.

FIG. 2 shows various example processing components of the wireless terminal device and the wireless access network node of FIG. 1.

FIG. 3 shows a communication timing diagram in accordance with various embodiments.

FIG. 4 shows a flow diagram in accordance with various embodiments.

FIG. 5 shows another example of a timing diagram in accordance with various embodiments.

### DETAILED DESCRIPTION

The technology and examples of implementations and/or embodiments described in this disclosure can be used to facilitate over-the-air radio resource allocation, configuration, and signaling in wireless access networks as well as operational configuration of a UE and/or a base station within the wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to handling transmissions in a wireless cellular access network and is specifically directed to mechanisms for providing commands regarding models (e.g., Artificial Intelligence/Machine Learning (AI/ML) models) and/or functionality.

### Wireless Network Overview

A wireless communication network may include a radio access network for providing network access to wireless terminal devices, and a core network for routing data between the access networks or between the wireless network and other types of data networks. In a wireless access network, radio resources are provided for allocation and used for transmitting data and control information. FIG. 1 shows an exemplary wireless access network 100 including a wireless access network node (WANN) or wireless base station 102 (herein referred to as wireless base station, base station, wireless access node, wireless access network node, or WANN) and a wireless terminal device or user equipment (UE) 104 (herein referred to as user equipment, UE, terminal device, or wireless terminal device) that communicates with one another via over-the-air (OTA) radio communication resources 106. The wireless access network 100 may be implemented as, as for example, a 2G, 3G, 4G/LTE, or 5G cellular radio access network. Correspondingly, the base station 102 may be implemented as a 2G base station, a 3G node B, an LTE eNB, or a 5G New Radio (NR) gNB. The user equipment 104 may be implemented as mobile or fixed communication devices installed with mobile identity modules for accessing the base station 102. The user equipment 104 may include but is not limited to mobile phones, laptop computers, tablets, personal digital assistants, wearable devices, distributed remote sensor devices, and desktop computers. Alternatively, the wireless access network 100 may be implemented as other types of radio access networks, such as Wi-Fi, Bluetooth, ZigBee, and WiMax networks.

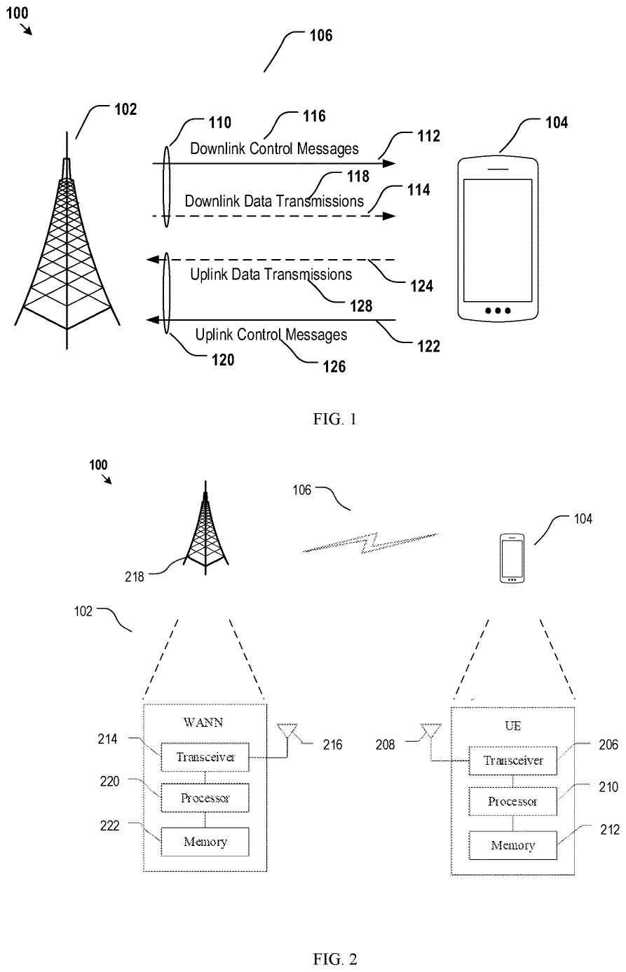

FIG. 2 further shows example processing components of the WANN 102 and the UE 104 of FIG. 1. The UE 104, for example, may include transceiver circuitry 206 coupled to one or more antennas 208 to effectuate wireless communication with the WANN 102 (or to other UEs). The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the, functions, methods, and processes of the UE 104 described herein. The memory 212 may also store therein, and the processor 210 may also be configured to execute one or more models (e.g., Artificial Intelligence/Machine Learning (AI/ML) models) to perform one or more functionalities (e.g., AI/ML functionalities). The memory 212 may also be utilized and allocated for buffering UL and DL transmissions in each band/carrier. The memory 212 may include multiple memory modules assigned to different functions (such as program memory, base band memory, and/or RF memory, to name a few). Likewise, the WANN 102 may include transceiver circuitry 214 coupled to one or more antennas 216, which may include an antenna tower 218 in various forms, to effectuate wireless communications with the UE 104. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions, methods, and processes of the WANN 102 described herein.

### Wireless Communication Resource Scheduling/Signaling

Returning to FIG. 1, the radio communication resources for the over-the-air interface 106 may include a combination of frequency, time, and/or spatial communication resources organized into various resource units or elements in frequency, time, and/or space. The radio communication resources 106 in frequency domain may include portions of licensed radio frequency bands, portions of unlicensed ration frequency bands, or portions of a mix of both licensed and unlicensed radio frequency bands. The radio communication resources 106 available for carrying the wireless communication signals between the base station 102 and user equipment 104 may be further divided into physical downlink channels 110 for transmitting wireless signals from the base station 102 to the user equipment 104 and physical uplink channels 120 for transmitting wireless signals from the user equipment 104 to the base station 102. The physical downlink channels 110 may further include physical downlink control channels (PDCCHs) 112 and physical downlink shared channels (PDSCHs) 114. Likewise, the physical uplink channels 120 may further include physical uplink control channels (PUCCHs) 122 and physical uplink shared channels (PUSCHs) 124. For simplification, other types of downlink and uplink channels are not shown in FIG. 1 but are within the scope of the current disclosure. The control channels PDCCHs 112 and PUCCHs 122 may be used for carrying control information in the form of control messages 116 and 126, herein referred to as Downlink Control Information (DCI) messages or Uplink Control Information (UCI) messages. The shared channels (shared between data and control information) PDSCHs 114 and PUSCHs 124 may be allocated and used for communicating downlink data transmissions 118 and uplink data transmissions 128 between the base station 102 and the user equipment 104.

The allocation and configuration of the radio communication resources associated with the data channels, such as the PDSCHs and the PUSCHs may be provided by one or more resource scheduling DCIs carried in the PDCCHs. The PDCCHs may be shared by a plurality of UEs in the access network. In various approaches, a particular UE may be configured to perform blind decode procedures on a preconfigured UE-specific Search Space (USS) to detect and identify a payload of a resource scheduling DCI carried in the PDCCH that specifically targets the particular UE. The blind decoding may be performed on preconfigured monitoring occasions of the PDCCH associated with USS. Such monitoring occasions may be referred to as a set of PDCCH candidates. Each PDCCH candidate may be associated with a set of Control Channel Elements (CCEs). The UE may specifically use its Radio Network Temporary Identifier (RNTI) to decode the PDCCH candidates. The RNTI may be used to demask a PDCCH candidate's CRC. If no CRC error is detected, the UE determines that PDCCH candidate carries its own control information. The UE may then process the DCI and extract the resource allocation information pertaining to the PDSCH and/or PUSCH for receiving and/or transmitting data.

Description of New Mechanisms for Providing Commands Regarding Model and/or Functionality Control

In accordance with the present disclosure, methods are disclosed for a base station 102 to control models and/or functionalities executed on a UE 104 side. In various embodiments, the base station 102 may transmit a first command to the UE 104 to indicate at least one of the following operations:

The UE 104 is to activate one or multiple models.

The UE 104 is to switch to another one or multiple models.

The UE 104 is to update the configurations or parameters of one or multiple models.

The UE 104 is to receive the one or multiple models transferred from base station.

The UE 104 is to perform performance monitoring of one or multiple model.

In addition, the first command may trigger the UE 104 to receive measurement resource transmission from the base station 102 to the UE 104. The UE 104 may then assess the performance of the one or multiple models based on the measurement resource transmitted from the base station 102.

In addition, optionally, the first command may trigger the UE 104 to generate a measurement report. The UE 104 may transmit the measurement report to the base station 102, where the measurement report is based on the measurement resource. In one embodiment, the measurement resource is the reference signal (RS) transmitted from base station 102 to the UE 104. In another embodiment, the measurement resource is a dataset that is indicated by the base station 102 or identified by a dataset ID.

As such, in accordance with various embodiments, a method performed by a WANN 102 (e.g., wireless base station 102) includes sending, to a wireless terminal device 104 (e.g., UE 104), a first command. Similarly, a method performed by the wireless terminal device 104 (e.g., UE 104) includes receiving, from the WANN 102, the first command. The first command commands the wireless terminal device 104 to perform, and the wireless terminal device 104 may perform, in response to a command in the first command, at least one of the following operations: activating one or multiple models; switching to another one or multiple models; updating a configuration or parameter of one or multiple models; receiving one or multiple models transferred from a network; and/or performing performance monitoring of one or multiple models. The wireless terminal device 104 may then receive, in response to receiving the first command, measurement resource transmission from the wireless access network node, and assess performance of the one or multiple models based on the measurement resource transmitted from the wireless access network node. The method may also include the wireless terminal device 104 generating, in response to receiving the first command or a second command from the WANN 102, a measurement report based on the measurement resource. The wireless terminal device 104 may then transmit, to the WANN 102, and the WANN 102 may receive, the measurement report.

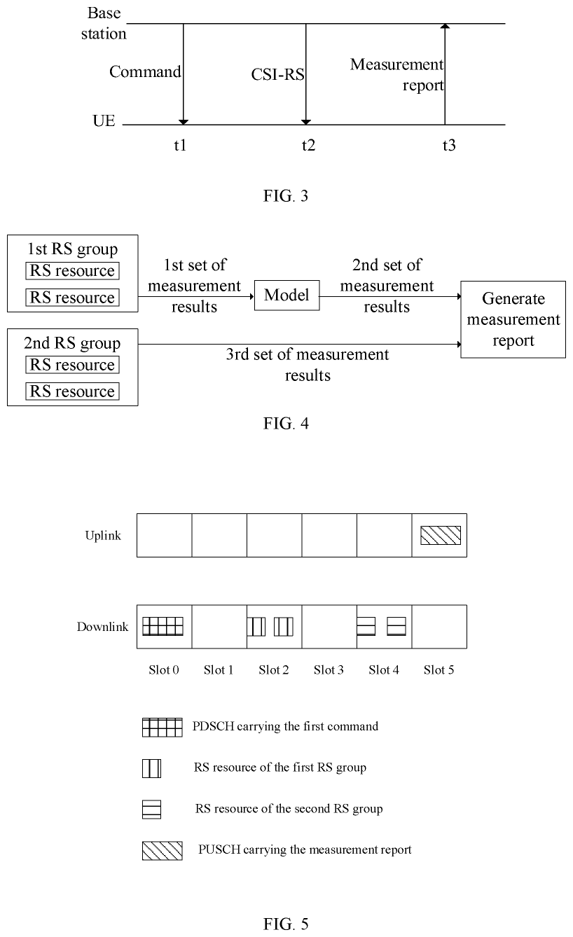

In one example, the base station 102 transmits a command to the UE 104, where the command indicates the UE 104 to activate two models for spatial domain prediction. The command also triggers Channel Start Information Reference Signal (CSI-RS) transmission from the base station 102 to the UE 104. In addition, the command also triggers a measurement report. The UE 104 may assess the performance of the two models based on the CSI-RS and transmit the measurement report to the base station 102. The performance of the two models may be included in the measurement report. The base station 102 may then determine whether to deactivate or switch the model based on the measurement report. FIG. 3 shows a timing diagram of communications between the base station 102 and the UE 104. As shown in FIG. 3, the base station 102 transmits the first command to the UE 104 at time t1, the first command triggers CSI-RS transmission at time t2, and triggers measurement report transmission at time t3.

### Measurement Resources

In one embodiment, the measurement resource is a reference signal (RS) transmitted from the base station 102 to the UE 104. In this example, the method may include the WANN 102 transmitting, to the wireless terminal device 104, and the wireless terminal device 104 receiving, the RS as the measurement resource.

In certain approaches, the measurement resource includes two groups of RS, i.e., a first RS group and a second RS group. In each group of the RS, there is one or multiple RS resources or RS resource sets. The RS resource sets includes one or multiple RS resources.

In certain embodiments, the UE 104 receives the RS in the first RS group and derives a first set of measurement results as the model input. The model generates a second set of measurement results as the model output based on the model input. The UE 104 also receives the RS in the second RS group and derives a third set of measurement results. The UE 104 generates the measurement report based on the second set of measurement results and the third set of measurement results.

FIG. 4 illustrates an example flow diagram of a procedure performed by the UE 104 and/or the base station 102 to generate a measurement report. In this example, the first RS group and the second RS group include two RS resources, respectively. For example, by comparing the second set of measurement results and the third set of measurement results, the UE 104 and/or the base station 102 can understand the performance of the model, e.g., predication accuracy.

As such, the method may include the WANN 102 transmitting, to the wireless terminal device 104, and the wireless terminal device 104 receiving two groups of RS as the measurement resource, including a first RS group and a second RS group, wherein each group of the RS includes one or multiple RS resources. The method may also include the wireless terminal device 104 receiving the one or multiple RS resources in the first RS group and deriving a first set of measurement results, and deriving a second set of measurement results based on the first set of measurement results and the one or multiple models. Alternatively, the method may include the wireless terminal device 104 receiving the one or multiple RS resources in the first RS group, and deriving a second set of measurement results based on the one or multiple RS resources in the first RS group and the one or multiple models. The method may also include the wireless terminal device 104 receiving the one or multiple RS resources in the second RS group and deriving a third set of measurement results based on the one or multiple RS resources in the second RS group. The method may also include the wireless terminal device 104 generating the measurement report based on the second set of measurement results and the third set of measurement results, and the wireless terminal device 104 transmitting, and the WANN 102 receiving the measurement report.

In various embodiments, the base station 102 indicates the timing information of the two groups of RS to the UE 104. In one approach, the RSs in the first RS group and the second RS group are transmitted at different times (e.g., different slots, different symbols, different sub-frames, or different frames), and the RSs in the second RS group is transmitted later than those in the first RS group.

For example, assuming the first RS group and second group of RS are transmitted at time T1 and T2, respectively. Time T1 is earlier than Time T2. In this case, the UE 104 can use the measurement result based on the first RS group at T1 as the input to the model to predict the measurement result (i.e., predicted result) for time T2. Then, the UE 104 may derive the measurement result by measuring the second RS group (i.e., the measured result). By comparing the predicted result and the measured result, the UE 104 and base station 102 can understand the overall performance (e.g., prediction accuracy) of the model. One of the potential use cases for this solution is to perform time domain predication, e.g., time domain beam predication.

In certain approaches, the timing information of the two RS groups may include at least one of the following alternatives. In a first alternative, the timing information includes the starting time of the first RS group and the starting time of the second RS group. For example, the starting time can be a slot or symbol where the RSs in the first RS group starts transmission. The starting time can be indicated, for example, one offset compared to a reference time. The reference time can be the slot or symbol where the first command is transmitted. The offset can be indicated by the first command or can be configured by the RRC signaling. In one embodiment, the RSs in the first RS group are transmitted in consecutive DL slots, and then the UE 104 can derive the transmission time for each RS of the first group based on the starting time of the first RS group. In another embodiment, the base station 102 may indicate other configurations (e.g., time offset for each RS resource in the first group) to the UE 104. The UE 104 can then derive the transmission time for each RS resource in the first group. Similar mechanisms for transmission time determination can be applied for the second RS group.

In a second alternative, the timing information includes the starting time of the first RS group and a time offset between the first RS group and the second RS group. The time offset between the first RS group and the second RS group can be defined as time offset between the starting time of the first RS group and the starting time of the second RS group, or defined as time offset between the end of the first RS group and the starting time of the second RS group. With the time offset, the UE 104 can determine the starting time of the second RS group. Similar mechanisms as described above in the first alternative for determining transmission time for each RS in the first group and the second group can be applied in the second alternative, as well.

As an example, with reference to FIG. 5, which shows an example timing diagram, the PDSCH carrying the first command may be transmitted in slot 0. The first command triggers transmission of two groups of RS, i.e., the first RS group transmitted in slot 2 and the second RS group transmitted in slot 4. The starting time of first RS group is the start of the slot 2, and the starting time of the second RS group is the start of the slot 4. The base station 102 can indicate the starting time of the first RS group (i.e., slot 2 in this example) and the starting time of the second RS group (i.e., slot 4 in this example) to the UE 104 directly (first alternative). Alternatively, the base station 102 can indicate the starting time of the first RS group (i.e., slot 2 in this example) and the offset between the starting time of the two groups (i.e., 2 slots in this example) to the UE 104 (second alternative).

As such, the method may include the WANN 102 indicating, to the wireless terminal device 104, and the wireless terminal device 104 receiving an indication of timing information of the two groups of RS, wherein the first RS group and the second RS group are transmitted at different times, wherein the first RS group is transmitted at time T1 and the second group of RS is transmitted at time T2, wherein time T1 is earlier than time T2. The method may also include the WANN 102 indicating, to the wireless terminal device 104, and the wireless terminal device 104 receiving an indication of the timing information of the two groups of RS, including at least one of the following: a starting time of the first RS group and a starting time of the second RS group; and/or the starting time of the first RS group and a time offset between the first RS group and the second RS group.

In a different embodiment, the first RS group and the second RS group may be transmitted at the same time (e.g., same slots or same symbols or same sub-frames), but with a different number of RS resources and/or with different number of ports.

In this case, the UE 104 can use the measurement result based on the first RS group as the input to the model to predict the measurement result (i.e., predicted result) for the second RS group. Then, the UE 104 can derive the measurement result by measuring the second RS group (i.e., the measured result). By comparing the predicted result and the measured result, the UE 104 and the network (e.g., base station 102) can understand the overall performance (e.g., prediction accuracy) of the model. One potential use case of this solution is to perform spatial domain beam prediction. For example, the first RS group may include RS resources for 8 beams (e.g., 8 RS resources), and the second RS group may include RS resources for 32 beams (e.g., 32 RS resources). By comparing the predicted result and the measured result, the UE 104 and the base station 102 can understand the spatial domain beam prediction performance of this model.

In one embodiment, the base station 102 can indicate a repetition number of the first RS group and/or the second RS group. For example, if the base station 102 indicates the repetition number as N for the first group and second group of RS, where N is an integer number and N is larger than 0, then the base station 102 transmits the RS resources in the first group N times and transmits the RS resources in the second group N times. The UE 104 can derive the measure results based on all the repeated RS resources, e.g., by deriving average result.

The relationship between the first RS group and the second RS group can be at least one of the following alternatives. In a first alternative, the first group of the RS and second the group of RS are the same. For example, if the first RS group includes four RSs (RS #1, RS #2, RS #3 and RS #4) and the second RS group includes four RSs (RS #1, RS #2, RS #3 and RS #4), then the first group of the RS and the second the group of RS are the same. One typical use case for this solution is to perform time domain predication, e.g., applying the measurement result from the first group of the RS to predict the measurement results of the second RS group transmitted at a later time.

In a second alternative, the first group of the RS is a subset of the second RS group. For example, the first group of the RS may include four RS resources (RS #1, RS #2, RS #3 and RS #4) and the second RS group may include eight RS resources (RS #1, RS #2, RS #3 and RS #4, RS #5, RS #6, RS #7 and RS #8). The potential use cases for this solution can be time domain predication or spatial domain predication, etc.

In a third alternative, the first group of the RS and the second RS group are different. The first group of the RS is not the same as the second RS group, and the first group of the RS may not be a subset of the second RS group.

As such, the method may include the WANN 102 transmitting to the wireless terminal device 104, and the wireless terminal device 104 receiving the two groups of RS as the measurement resource at a same time. The method may also include the WANN 102 transmitting to the wireless terminal device 104, and the wireless terminal device 104 receiving the two groups of RS as the measurement resource, wherein the first RS group has a different number of RS resources and/or different number of ports than the second RS group. The method may also include the WANN 102 indicating to the wireless terminal device 104, and the wireless terminal device 104 receiving an indication of a repetition number of the first RS group and/or the second RS group. In various examples, the RS resources of the first RS group may be the same as the RS resources of the second RS group, or the RS resources of the first RS group may be a subset of the RS resources of the second RS group.

In another embodiment, the measurement resource includes one group of RS. In the group of the RS, there is one or multiple RS resources or RS resource sets. The base station 102 may indicate the timing information of the group of RS to the UE 104. The timing information can include the starting time of the group of RS. For example, the starting time can be a slot or symbol where the group of RS starts transmission. The starting time can be indicated by one reference time and one offset. The reference time can be the slot or symbol where the first command is transmitted. The offset can be indicated by the first command or configured by the RRC signaling. In one embodiment, the RSs in the group are transmitted in consecutive DL slots, then the UE 104 can derive the transmission time for each RS resource of the group based on the starting time of the first RS group. In another embodiment, the base station 102 can indicate other configurations (e.g., time offset for each RS resource in the group) to the UE 104, and the UE 104 can derive the transmission time for each RS resource in the group.

In this case, the UE 104 can measure the RS and derive the first measurement result. Then the UE 104 can use the first measurement result as the input to the model to perform predication and to generate the second measurement result (i.e., predicted result). In addition, the UE 104 can measure the RS and derive the measured third measurement result (i.e., the measured result). By comparing the predicted result and the measured result, the UE 104 and the network (e.g., the base station 102) can understand the overall performance (e.g., prediction accuracy) of the model.

In another embodiment, the UE 104 can measure the RS and derive the first measurement result. Then the UE 104 can use the first measurement result as the input to the model to perform predication and generate the second measurement results. By analyzing the data distribution of the first measurement result and/or the second measurement result, the UE 104 and the network (e.g., base station 102) can understand the overall performance or situation (e.g., whether the existing model fits the existing channel status) of the model.

As such, the method may include the WANN 102 transmitting to the wireless terminal device 104, and the wireless terminal device 104 receiving one group of RS as the measurement resource, wherein the group of RS includes one or multiple RS resources. The method may include the WANN 102 indicating to the wireless terminal device 104, and the wireless terminal device 104 receiving an indication of timing information of the group of RS, wherein the timing information includes a starting time of the group of RS. The method may include the wireless terminal device 104 receiving the one or multiple RS resources in the group of RS, deriving a first set of measurement results, and deriving a second set of measurement results based on the first set of measurement results and the one or multiple models. Alternatively, the method may include the wireless terminal device 104 receiving the one or multiple RS resources in the group of RS, and deriving a second set of measurement results based on the one or multiple RS resources in the group of RS and the one or multiple models. The method may also include the wireless terminal device 104 deriving a third set of measurement results based on the one or multiple RS resources in the second RS group. The method may also include the wireless terminal device 104 generating the measurement report based on the second set of measurement results and the third set of measurement results, and the wireless terminal device 104 transmitting, and the WANN 102 receiving, the measurement report.

In another embodiment, the measurement resource is a dataset indicated by the base station 102 or identified by a dataset ID. The base station 102 may transmit the dataset or dataset ID to the UE 104. The transmitted dataset or dataset identified by the transmitted dataset ID may include two parts, where one is the model input dataset and another part is the nominal model output dataset.

The UE 104 may use the model input dataset as the input to its model and generate the actual model output dataset. The UE 104 may generate the measurement report based on the nominal model output dataset and the actual model output dataset. For example, by comparing the nominal model output dataset and actual model output dataset, the UE 104 and the base station 102 can understand the performance of the model.

As such, the method may include the WANN 102 indicating to the wireless terminal device 104, and the wireless terminal device 104 receiving an indication of a dataset as the measurement resource. The method may further include the WANN 102 transmitting to the wireless terminal device 104, and the wireless terminal device 104 receiving the dataset or a dataset ID, wherein the dataset or a dataset identified by the dataset ID includes a model input dataset and a nominal model output dataset. The method may include the wireless terminal device 104 using the model input dataset as an input to the one or multiple models to generate an actual model output dataset, and generating the measurement report based on the nominal model output dataset and the actual model output dataset.

### Measurement Report

As discussed above, the measurement resource can be a reference signal (RS) or a dataset indicated by the base station 102 or identified by a dataset ID. The measurement report generated based on a dataset is similar to a measurement report generated based on the reference signal. However, some differences exist. For a measurement report generated based on reference signal, the UE 104 may derive the model input based on the first set of measurement results, and may derive the nominal model output based on the third set of measurement results. For a measurement report generated based on a dataset, the UE 104 may derive the model input and the nominal model output based on the dataset indicated by the base station 102. Thus, similar mechanisms for measurement reports generated based on the reference signal and a dataset are disclosed.

In various embodiments, the first set of measurement results or model input dataset may be channel information derived by the RS resources in the first RS group, e.g., channel matrix, channel phase information, channel impulse response information, timing information of the RS resources, signal to interference & noise ratio (SINR), reference signal received power (RSRP), received signal strength indicator (RSSI), reference signal received quality (RSRQ), etc.

The second set of measurement results or nominal model output dataset can be different for different use cases. Typically, the second set of measurement results or nominal model output dataset can be at least one of the following metrics:

Channel/signal information—For example, channel state information (CSI), precoding matrix indicator (PMI), channel quality indicator (CQI), rank indicator (RI), reference signal received power (RSRP), received signal strength indication (RSSI), reference signal received quality (RSRQ), signal to interference & noise ratio (SINR), signal to noise ratio (SNR), block error rate (BLER), channel phase information, channel impulse response information and/or timing information etc.

UE (wireless terminal device) location information—For example, absolute position or relative position, distance from the base station 102, distance from the reference point and/or UE trajectory, etc.

Beam information—For example, the beam index with best quality, the beam index with quality over a threshold, the best K (K is integer number larger than 1) beam indexes and/or the best K beam indexes with quality over a threshold, etc. The threshold can be defined or configured by the base station 102. In some instances, the beam can be represented by RS resources, e.g., one RS resource represents one beam, multiple different RS resources represent multiple different beams.

In one embodiment, the third set of measurement results have the same metrics as the second set of measurement results. In one embodiment, the nominal model output dataset has the same metrics as the actual model output dataset.

In one embodiment, the measurement report includes both the second set of measurement results and the third set of measurement results. As such, the method may include the wireless terminal device 104 transmitting, and the WANN 102 receiving, the measurement report including the second set of measurement results and the third set of measurement results. After receiving the second set of measurement results and the third set of measurement results, the base station 102 can determine how the model performs by comparing them. For example, the UE 104 may report the RSRP information in the second set of measurement results and the third set of measurement results to base station 102. The measurement report may only include the average value of results of the second set of measurement results and the average value of results of the third set of measurement results.

In one embodiment, the measurement report can include both the first set of measurement results and the third set of measurement results. This method may be used for the network side model such that base station 102 can determine the performance of the model at the network side.

In one embodiment, the measurement report includes the difference or similarity between the second set of measurement results and the third set of measurement results. In one embodiment, the measurement report includes the difference or similarity between the nominal model output dataset and the actual model output dataset.

The below example is based on the second set of measurement results and the third set of measurement results. The same embodiment can be applied for the nominal model output dataset and the actual model output dataset by replacing the second set of measurement results as the nominal model output dataset and replacing the third measurement results as the actual model output dataset.

The difference can be defined as the absolute difference or relative difference between these two sets of measurement results. For example, if the RSRP values in the second set of measurement results are {−40 dB, −41 dB, −42 dB} and the RSRP values in the third set of measurement results are {−40 dB, −40 dB, −43 dB}, the absolute difference of RSRP can be {0 dB, −1 dB, 1 dB}, and the relative difference of RSRP can be {0, −1/100, 1/100} assuming 100 as the maximum difference value. Other methods can also be applied to derive the absolute difference or relative difference. The similarity can be defined as Euclidean Distance, Manhattan Distance, Chebyshev Distance, standardized Euclidean distance, cosine similarity, or squared generalized cosine similarity (SGCS), etc. Other methods can also be considered to calculate the similarity between the second set of measurement results and the third set of measurement results.

Take the cosine similarity as an example, one equation to calculate the cosine similarity between the second set of measurement results and the third set of measurement results can be the following:

$${S}_{C} ( A , B ) = \frac{{\sum }_{i = 1}^{n} {A}_{i} {B}_{i}}{\sqrt{{\sum }_{i = 1}^{n} {A}_{i}^{2} \cdot {\sum }_{i = 1}^{n} {B}_{i}^{2}}} ,$$

where A and B are the second set of measurement results and the third set of measurement results, respectively. Aᵢ and Bᵢ are the values in the second set of measurement results and the third set of measurement results, respectively. For example, Aᵢ and Bᵢ can be the RSRP values. n is the number of values in the second set of measurement results and the third set of measurement results.

In one embodiment, the measurement report includes the prediction accuracy based on the second set of measurement results and the third set of measurement results. In one embodiment, the measurement report includes the prediction accuracy based on the nominal model output dataset and the actual model output dataset.

The below embodiment is based on the second set of measurement results and the third set of measurement results. The same embodiment can be applied for the nominal model output dataset and the actual model output dataset by replacing the second set of measurement results as the nominal model output dataset and replacing the third measurement results as the actual model output dataset.

An acceptable error range can be defined or configured, as long as the difference between the value in the second set of measurement results and the corresponding value in the third set of measurement results is within the error range, then it can be considered as accurate prediction. Other methods can also be applied to define the prediction accuracy, if the best K (K is integer number larger than 1) beam indexes are selected as the metric, as long as more than X % of the K beams are aligned with the actual measured results, then this predication can be considered as accurate. The value of X can be defined or configured.

The prediction accuracy can also be the number of samples considered as accurate prediction or the percentage of samples of that are considered as accurate prediction.

One sample can be the measurement results of one RS resource or the average value of the measurement results of all the RS resources on the RS group. For example, if the RS resources in the RS group are repeated 10 times, then the UE 104 can derive 10 average prediction accuracy with one for each repetition. The prediction accuracy can also be average value among multiple measurements. Alternatively, for one sample can be one prediction instance based on the dataset. The base station 102 may indicate the number of predication instances and the corresponding dataset for each prediction instance.

In one embodiment, the measurement report includes the instances that are considered as accurate prediction or instances that are considered as inaccurate prediction. In this case, the base station 102 can understand the prediction accuracy distribution and make the right decision. For example, if the last 3 instances are inaccurate prediction, even though the average prediction accuracy may be high, it may be risky to apply this model since there is a tendency of inaccurate prediction of this model.

In one embodiment, if the UE 104 performs K inaccurate prediction in a row, to avoid wasting measurement resources and time, the UE 104 can stop the measurement and report this event to the base station 102. Once the base station 102 receives this event, the base station 102 understands the performance of this model at the UE 104 side is not acceptable currently. K is integer number and K is larger than 1. K can be defined or configured by the RRC signaling.

In another embodiment, the measurement report includes index(es) of a recommended one or multiple models from the UE 104. The recommended model(es) can be the one or multiple models with best performance or performance above a performance threshold defined or configured by the base station 102. For example, if the base station 102 transmits a first command to activate three models at the UE 104 side, the UE 104 may derive the prediction accuracy of the three models and recommend the model with the best prediction accuracy to the base station 102. As such, the method may include the wireless terminal device 104 transmitting, and the WANN 102 receiving, the measurement report including at least one index of a recommended one or more models from the wireless terminal device.

Alternatively, the measurement report may include index(es) of an unrecommended one or multiple models from the UE 104. The unrecommended model(s) can be the one or multiple models with worst performance or performance below a performance threshold defined or configured by the base station 102. In other words, the unrecommended models can be the models that the UE 104 recommends to deactivate.

In various embodiments, the base station 102 may indicate the starting time of the channel/signal carrying the measurement report. The starting time can be a starting slot and/or starting symbol when the UE 104 starts transmitting the channel/signal carrying the measurement report. The starting time can be indicated by an offset compared to a reference point. The base station 102 may indicate the offset in the first command or via RRC signaling. The reference point can be one of the following alternatives:

Alternative 1: The slot or symbol where the first command is transmitted.

Alternative 2: The slot or symbol that is X time units after the slot or symbol where the first command is transmitted. Time units can be millisecond, symbols or slots. The X time units may be used for the UE 104 to process the first command. For example, typically, X time units are 3 ms for the UE 104 to process the first command carried by Medium Access Control Control Element (MAC-CE).

Alternative 3: The slot or symbol where the Hybrid Automatic Repeat Request Acknowledgement (HARQ-ACK) feedback information for the first command is transmitted.

Alternative 4: The slot or symbol that is X time units after the slot or symbol where the HARQ-ACK feedback information for the first command is transmitted. Similarly, time units can be millisecond, symbols or slots. The X time units are used for the UE 104 to process the first command. For example, typically, X time units are 3 ms for the UE 104 to process the first command carried by MAC-CE.

Alternative 5: The slot or symbol where the measurement resource finishes transmission.

Alternative 6: The next slot or symbol where the measurement resource finishes transmission.

In one embodiment, the base station 102 indicates the channel/signal type to transmit the measurement report. Alternatively, the UE 104 determines the corresponding channel/signal type to transmit the measurement report based on the size of the measurement report. For example, if the size of measurement report is limited (e.g., less than 45 bits), PUCCH may be selected to transmit the measurement report. However, if the size of measurement report is large, PUSCH may be selected to transmit the measurement report.

As such, the method may include the WANN 102 indicating to the wireless terminal device 104, and the wireless terminal device 104 receiving an indication of a starting time of the channel or signal carrying the measurement report. This may further include the WANN 102 indicating to the wireless terminal device 104, and the wireless terminal device 104 receiving an indication of an offset compared to a reference point, wherein the reference point is one of the following: a slot or symbol where the first command is transmitted; a slot or symbol where HARQ-ACK feedback information for the first command is transmitted; or a slot or symbol where the measurement resource finishes transmission.

### First Command Design

In various embodiments, the first command can be or can be sent and received via MAC-CE, DCI, or other level 1 or level 2 (L1/L2) signaling.

In one embodiment, one index or multiple indexes are included in the first command, where each index corresponds to one set of RS configurations and measurement report configurations. In another embodiment, two different kinds of indexes are included in the first command, where each index of the first kind of indexes corresponds to one set of RS configurations and each index of the second kind of indexes corresponds to one set of measurement report configurations.

In another embodiment, one index or multiple indexes are included in the first command, where each index corresponds to one set of dataset configurations and measurement report configurations. In another embodiment, each index may correspond to one set of dataset configurations only.

The dataset configurations may include the dataset ID, the size or dimension of the first part (i.e., model input dataset), the size or dimension of the second part (i.e., nominal model output dataset), or other related configurations.

The RS configurations may include the configurations for the RS group(s), more specifically, the RS configuration includes the starting time of the RS group. In addition, the RS configuration can further include the following configurations:
Repetition number of each RS group;
Frequency domain resource of the RS resources for each RS group;
Antenna port configuration;
Transmission power configuration; or
Other related configurations.

The measurement report configurations may include the configurations of the report metrics and the starting time of the channel/signal carrying the measurement report. In addition, measurement report configurations can further include the following configurations:
Channel/signal type to transmit the measurement report;
The size of the measurement report;
The priority of the measurement report; or
Other related configurations.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation/example/approach” as used herein does not necessarily refer to the same embodiment and the phrase “in another embodiment/implementation/example/approach” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a wireless terminal device comprising:
receiving, from a wireless access network node, a first command,
performing, in response to a command in the first command, at least one of the following operations:
activating one or multiple artificial (AI)/machine learning (ML) functionalities;
switching to another one or multiple AI/ML functionalities;
updating a configuration or parameter of one or multiple AI/ML functionalities;
receiving one or multiple AI/ML functionalities transferred from a network; or
performing performance monitoring of one or multiple AI/ML functionalities;
receiving, in response to receiving the first command, measurement resource transmission from the wireless access network node; and
assessing performance of the one or multiple AI/ML functionalities based on the measurement resource transmitted from the wireless access network node.

2. The method according to claim 1, further comprising:
generating, in response to receiving the first command or a second command from the wireless access network node, a measurement report based on the measurement resource; and
transmitting, to the wireless access network node, the measurement report.

3. The method according to claim 1, further comprising:
receiving, from the wireless access network node, a reference signal (RS) as the measurement resource;
receiving, from the wireless access network node, two groups of RS as the measurement resource, including a first RS group and a second RS group, wherein each group of the RS includes one or multiple RS resources;
receiving the one or multiple RS resources in the first RS group, and deriving a second set of measurement results based on the one or multiple RS resources in the first RS group and the one or multiple AI/ML functionalities;
receiving the one or multiple RS resources in the second RS group and deriving a third set of measurement results based on the one or multiple RS resources in the second RS group; and
generating a measurement report based on the second set of measurement results and the third set of measurement results.

4. The method according to claim 3, further comprising at least one of:
receiving, from the wireless access network node, the two groups of RS as the measurement resource, wherein the first RS group has a different number of RS resources and/or different number of ports than the second RS group;
receiving, from the wireless access network node, an indication of a repetition number of the first RS group and/or the second RS group; or
wherein the RS resources of the first RS group are the same as the RS resources of the second RS group, or the RS resources of the first RS group is a subset of the RS resources of the second RS group.

5. The method according to claim 1, comprising:
receiving, from the wireless access network node, one group of RS as the measurement resource, wherein the group of RS includes one or multiple RS resources.

6. The method according to claim 5, further comprising:
receiving the one or multiple RS resources in the group of RS, and deriving the second set of measurement results based on the one or multiple RS resources in the group of RS and the one or multiple AI/ML functionalities; and deriving the third set of measurement results based on the one or multiple RS resources in the second RS group;
transmitting, to the wireless access network node, a measurement report based on the second set of measurement results and the third set of measurement results.

7. The method according to claim 1, further comprising:
receiving, from the wireless access network node, an indication of a dataset as the measurement resource;
receiving, from the wireless access network node, the dataset or a dataset ID, wherein the dataset or a dataset identified by the dataset ID includes a model input dataset and a nominal model output dataset;
using the model input dataset as an input to the one or multiple AI/ML functionalities to generate an actual model output dataset; and
generating a measurement report based on the nominal model output dataset and the actual model output dataset.

8. The method according to claim 3,
wherein the third set of measurement results have same metrics as the second set of measurement results, or
wherein the actual model output dataset has same metrics as the nominal model output dataset.

9. The method according to claim 3, further comprising:
transmitting, to the wireless access network node, the measurement report including the second set of measurement results and the third set of measurement results; or
transmitting, to the wireless access network node, the measurement report including a difference or similarity between the second set of measurement results and the third set of measurement results; or
transmitting, to the wireless access network node, the measurement report including a difference or similarity between a nominal model output dataset and an actual model output dataset; or
transmitting, to the wireless access network node, the measurement report including a prediction accuracy based on the second set of measurement results and the third set of measurement results; or
transmitting, to the wireless access network node, the measurement report including a prediction accuracy based on the nominal model output dataset and the actual model output dataset.

10. The method according to claim 9,
wherein the prediction accuracy includes a number of samples considered as accurate prediction or a percentage of samples of that are considered as accurate prediction.

11. An apparatus for wireless communication comprising a processor that is configured to carry out the method of claim 1.

12. A method performed by a wireless access network node comprising:
sending, to a wireless terminal device, a first command,
wherein the first command commands the wireless terminal device to perform at least one of the following operations:
activate one or multiple artificial intelligence (AI)/machine learning (ML) functionalities;
switch to another one or multiple AI/ML functionalities;
update a configuration or parameter of one or multiple AI/ML functionalities;
receive one or multiple AI/ML functionalities transferred from a network; or
perform performance monitoring of one or multiple AI/ML functionalities;
wherein the first command also triggers the wireless terminal device to:
receive measurement resource transmission from the wireless access network node,
wherein the wireless terminal device assesses performance of the one or multiple AI/ML functionalities based on the measurement resource transmitted from the wireless access network node.

13. The method according to claim 12, further comprising:
receiving, from the wireless terminal device, a measurement report, wherein the measurement report is based on the measurement resource, and wherein the first command or a second command triggers transmission of the measurement report by the wireless terminal device.

14. The method according to claim 12, further comprising:
transmitting, to the wireless terminal device, a reference signal (RS) as the measurement resource;
transmitting, to the wireless terminal device, two groups of RS as the measurement resource, including a first RS group and a second RS group, wherein each group of the RS includes one or multiple RS resources, wherein the wireless terminal device receives the one or multiple RS resources in the first RS group, and derives a second set of measurement results based on the one or multiple RS resources in the first RS group and the one or multiple AI/ML functionalities, and wherein the wireless terminal device receives the one or multiple RS resources in the second RS group and derives a third set of measurement results based on the one or multiple RS resources in the second RS group; and
receiving, from the wireless terminal device, the measurement report, wherein the measurement report is generated by the wireless terminal device based on the second set of measurement results and the third set of measurement results.

15. The method according to claim 14, further comprising at least one of:
transmitting, to the wireless terminal device, the two groups of RS as the measurement resource, wherein the first RS group has a different number of RS resources and/or different number of ports than the second RS group;
indicating, to the wireless terminal device, a repetition number of the first RS group and/or the second RS group; or,
wherein the RS resources of the first RS group are the same as the RS resources of the second RS group, or the RS resources of the first RS group is a subset of the RS resources of the second RS group.

16. The method according to claim 12, further comprising:
transmitting, to the wireless terminal device, one group of RS as the measurement resource, wherein the group of RS includes one or multiple RS resources.

17. The method according to claim 16,
wherein the wireless terminal device receives the one or multiple RS resources in the group of RS, and derives a second set of measurement results based on the one or multiple RS resources in the group of RS and the one or multiple AI/ML functionalities, and wherein the wireless terminal device derives a third set of measurement results based on the one or multiple RS resources in the second RS group, and
wherein the method further comprises:
receiving, from the wireless terminal device, the measurement report, wherein the measurement report is generated by the wireless terminal device based on the second set of measurement results and the third set of measurement results.

18. The method according to claim 12, further comprising:
indicating, to the wireless terminal device, a dataset as the measurement resource; and
transmitting, to the wireless terminal device, the dataset or a dataset ID,
wherein the dataset or a dataset identified by the dataset ID includes a model input dataset and a nominal model output dataset,
wherein the wireless terminal device uses the model input dataset as an input to the one or multiple models to generate an actual model output dataset, and
wherein the wireless terminal device generates the measurement report based on the nominal model output dataset and the actual model output dataset.

19. The method according to claim 14,
wherein the third set of measurement results have same metrics as the second set of measurement results, or
wherein the actual model output dataset has same metrics as the nominal model output dataset.

20. The method according to claim 14, further comprising:
receiving the measurement report including the second set of measurement results and the third set of measurement results; or
receiving the measurement report including a difference or similarity between the second set of measurement results and the third set of measurement results; or
receiving the measurement report including a difference or similarity between a nominal model output dataset and an actual model output dataset; or
receiving the measurement report including a prediction accuracy based on the second set of measurement results and the third set of measurement results; or
receiving the measurement report including a prediction accuracy based on a nominal model output dataset and an actual model output dataset.

21. The method according to claim 20,
wherein the prediction accuracy includes a number of samples considered as accurate prediction or a percentage of samples of that are considered as accurate prediction.

22. An apparatus for wireless communication comprising a processor that is configured to carry out the method of claim 12.
